(19) United States
(12) Patent Application Publication
(10) Pub. No.: US 2005/0080567 A1
(43) Pub. Date: Apr. 14, 2005

(54) Grain bin monitoring system

(76) Inventors: Mel G. Wieting, Huron, SD (US); Terry M. Wieting, Hitchcock, SD (US)

Correspondence Address: Michael S. Neustel, Suite No. 4, 2534 South University Drive, Fargo, ND, 58103, US

(21) Appl. No.: 10/683,590

(22) Filed: Oct. 9, 2003

(51) Int. Cl. G06F 19/00

(52) U.S. Cl. 702/2

(57) ABSTRACT

A grain bin monitoring system for efficiently monitoring remote grain bins. The grain bin monitoring system includes a main station, a central unit in communication with the main station, a plurality of transmitter units in communication with the central unit, and at least one sensor positionable within a grain bin for determining condition data with respect to a grain bin. The sensor is in communication with one of the transmitter units for providing the condition data to the transmitter unit, wherein the transmitter unit automatically forwards the condition data to a central unit that automatically forwards the condition data to the main station. In the event of an alarm condition, an individual may be notified.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to grain bin monitors and more specifically it relates to a grain bin monitoring system for efficiently monitoring remote grain bins.

2. Description of the Related Art

Grain bins are utilized to store various types of grain such as wheat, corn and soybeans. Grain bins may be comprised of various structures, shapes and materials which is well known in the art. Grain bins have a storage reservoir that is capable of storing and protecting a volume of grain. Aerator units are sometimes fluidly connected to the grain bins to bring fresh air into the grain bin for drying the grain when the humidity levels are too high to avoid spoilage.

Conventional methods of monitoring grain bins require the user to physically visit each grain bin to measure the grain level, grain temperature and humidity within the grain bin. Another problem with conventional methods of monitoring grain bins is that they do not provide a convenient and easy to read chart/graph of the various grain conditions for a user to view.

While these devices may be suitable for the particular purpose to which they address, they are not as suitable for efficiently monitoring remote grain bins. Conventional grain bins are difficult to monitor from a distance.

In these respects, the grain bin monitoring system according to the present invention substantially departs from the conventional concepts and designs of the prior art, and in so doing provides an apparatus primarily developed for the purpose of efficiently monitoring remote grain bins.

### BRIEF SUMMARY OF THE INVENTION

In view of the foregoing disadvantages inherent in the known types of grain bin monitoring systems now present in the prior art, the present invention provides a new grain bin monitoring system construction wherein the same can be utilized for efficiently monitoring remote grain bins.

The general purpose of the present invention, which will be described subsequently in greater detail, is to provide a new grain bin monitoring system that has many of the advantages of the grain bin monitoring systems mentioned heretofore and many novel features that result in a new grain bin monitoring system which is not anticipated, rendered obvious, suggested, or even implied by any of the prior art grain bin monitoring systems, either alone or in any combination thereof.

To attain this, the present invention generally comprises a main station, a central unit in communication with the main station, a plurality of transmitter units in communication with the central unit, and at least one sensor positionable within a grain bin for determining condition data with respect to a grain bin. The sensor is in communication with one of the transmitter units for providing the condition data to the transmitter unit, wherein the transmitter unit automatically forwards the condition data to a central unit that automatically forwards the condition data to the main station. In the event of an alarm condition, an individual may be notified.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a grain bin monitoring system that will overcome the shortcomings of the prior art devices.

A second object is to provide a grain bin monitoring system for efficiently monitoring remote grain bins.

Another object is to provide a grain bin monitoring system that may be monitored from a remote location.

An additional object is to provide a grain bin monitoring system that may be utilized with various types of grain bins.

A further object is to provide a grain bin monitoring system that is capable of monitoring various grain conditions.

Another object is to provide a grain bin monitoring system that can notify a user of an alarm condition.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is diagram illustrating the overall communications of the present invention with a single transmitter unit.

FIG. 2 is a diagram illustrating the overall communications of the present invention with a plurality of transmitter units.

FIG. 3 is a block diagram illustrating the communications with the transmitter unit.

FIG. 4 is a diagram illustrating the transmitter unit connected to the sensors.

FIG. 5 is a flowchart illustrating the overall functionality of the present invention.

FIG. 6 is a flowchart illustrating the overall functionality of activating the aerator unit.

### DETAILED DESCRIPTION OF THE INVENTION

A. Overview

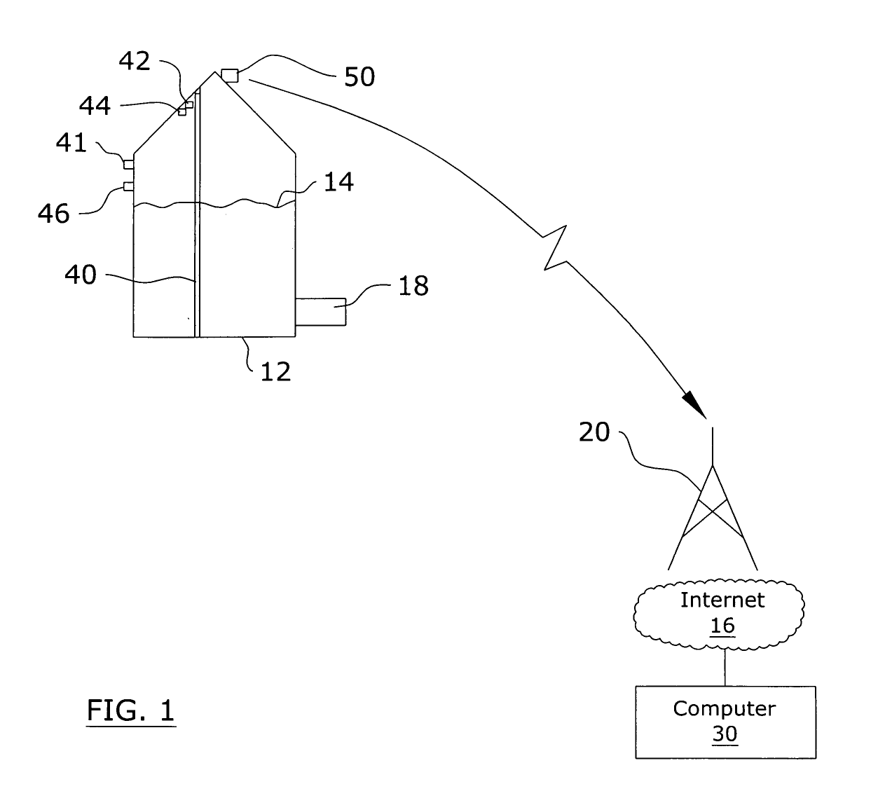

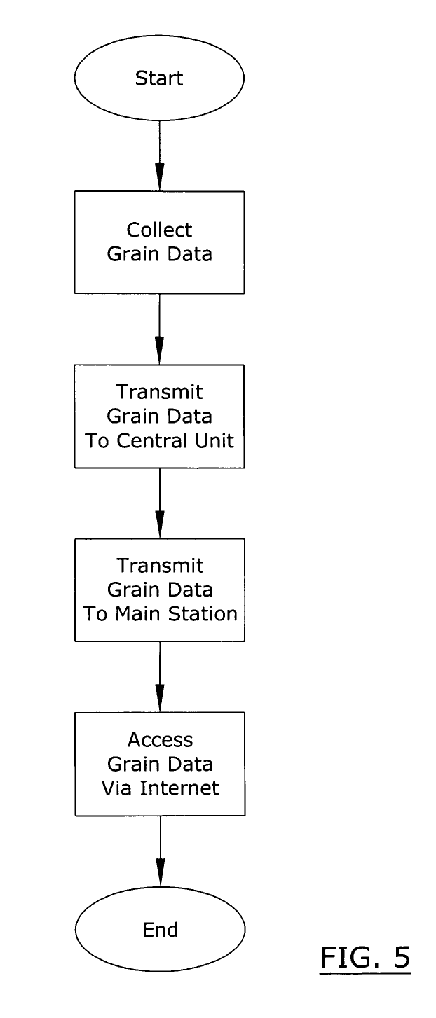

Turning now descriptively to the drawings, in which similar reference characters denote similar elements throughout the several views, FIGS. 1 through 6 illustrate a grain bin monitoring system 10, which comprises a main station 20, a central unit 60 in communication with the main station 20, a plurality of transmitter units 50 in communication with the central unit 60, and at least one sensor positionable within a grain bin 12 for determining condition data with respect to a grain bin 12. The sensor is in communication with one of the transmitter units 50 for providing the condition data to the transmitter unit 50, wherein the transmitter unit 50 automatically forwards the condition data to a central unit 60 that automatically forwards the condition data to the main station 20. In the event of an alarm condition, an individual may be notified.

B. Main Station

The main station 20 receives the condition data from the transmitter units 50 as shown in FIG. 1 of the drawings. The main station 20 may be comprised of any electronic device capable of receiving data communications via a signal or other communication means (e.g. computers 30, etc.). The main station 20 may be located in various remote locations near or far away from the grain bins 12 being monitored.

The main station 20 is preferably connected to a global computer 30 network (e.g. Internet 16). The main station 20 hosts and provides the condition data to one or more computers 30 via the Internet 16 in various forms such as but not limited to an HTML page. The main station 20 also preferably prepares charts and graphs which indicate grain level 14, temperature and humidity over a period of time for each grain bin 12 being monitored.

C. Central Unit

When more than one transmitter unit 50 is utilized, a central unit 60 is preferably utilized to combine the condition data for each of the transmitter units 50. If only one transmitter unit 50 is utilized, the transmitter unit 50 may communicate directly with the main station 20 without the usage of a central unit 60 as shown in FIG. 1 of the drawings.

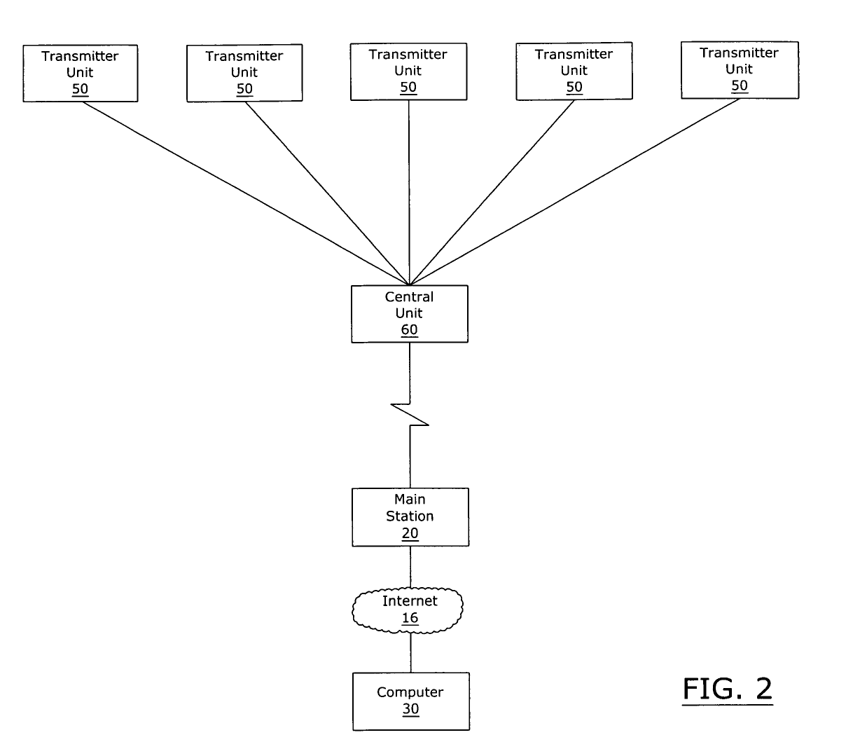

The central unit 60 is in communication with the main station 20 as shown in FIG. 2 of the drawings. The central unit 60 is in communication with the main station 20 via a signal (e.g. radio, wire, etc.). The central unit 60 may be comprised of any computer 30 device capable of accumulating condition data from a plurality of transmitter units 50 and sending the condition data for each grain bin 12 to the main station 20 for additional data manipulation.

D. Transmitter Units

The plurality of transmitter units 50 in communication with the central unit 60 as shown in FIG. 2 of the drawings. If a single transmitter unit 50 is utilized, the transmitter unit 50 may communicate directly with main station 20 as shown in FIG. 1 of the drawings. The transmitter units 50 may communicate constantly or periodically with the central unit 60 (or the main station 20) via a conventional communication system (e.g. radio, wire, etc.).

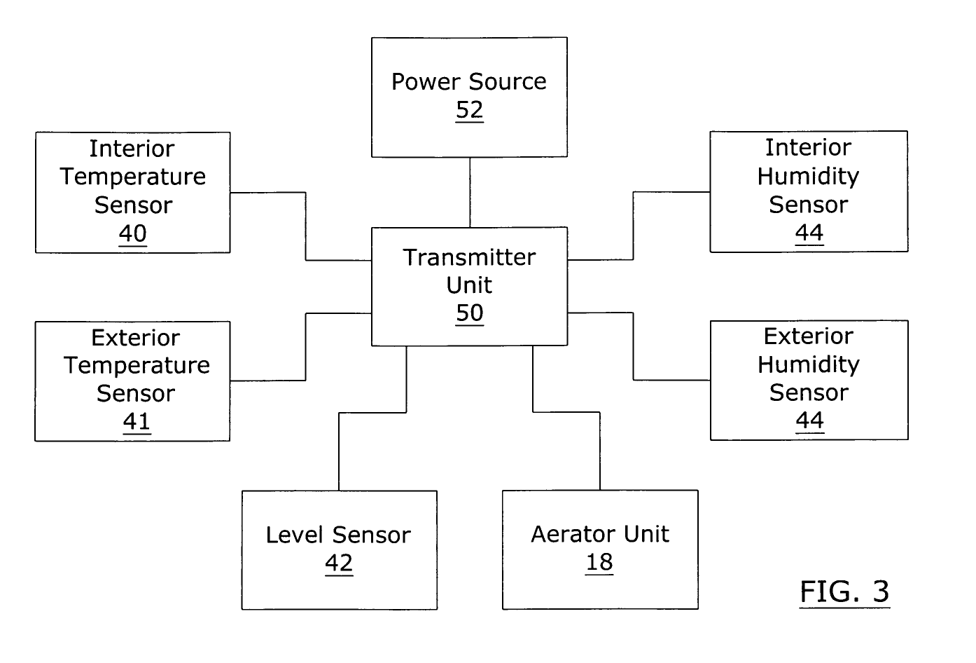

The transmitter units 50 may be comprised of any electronic device capable of receiving and manipulating condition data received from the sensors. The transmitter units 50 preferably send the condition data for each grain bin 12 to the central unit 60 (or main station 20) for additional data manipulation. The transmitter unit 50 is preferably connected to a power source 52 such as batteries, direct power or solar power as shown in FIG. 3 of the drawings.

E. Sensors

At least one sensor 40, 41, 42, 44, 46 is positionable within or exterior of a grain bin 12 for determining condition data with respect to a grain bin 12. The condition data may be comprised of interior temperature, grain temperature, exterior temperature, humidity, grain level 14 and other conditions relating to a grain bin 12 and grain.

The sensors 40, 41, 42, 44, 46 are in communication with the transmitter unit 50 as shown in FIG. 3 of the drawings. The transmitter unit 50 automatically forwards the condition data to the central unit 60 (or main station 20) that automatically forwards the condition data to the main station 20.

As shown in FIGS. 1, 3 and 4 of the drawings, the sensors 40, 41, 42, 44 may be comprised of an interior temperature sensor that measures the interior temperature of a grain bin 12 and the temperature of the grain at various levels, an exterior temperature sensor for measuring the temperature exterior of a grain bin 12, a level sensor positionable within a grain bin 12 for measuring a grain level 14 within a grain bin 12, and a humidity sensor for measuring the humidity level within a grain bin 12. An exterior humidity sensor may also be utilized in communication with the transmitter unit 50 to measure the humidity of the air external of the grain bin 12.

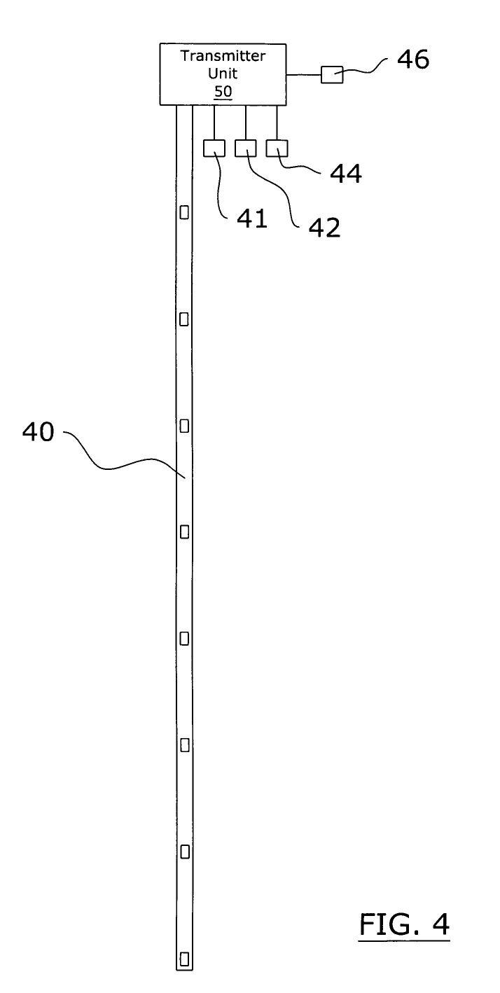

The interior temperature sensor may be comprised of an elongate vertically orientated structure as shown in FIG. 4 of the drawings. The boxes within the interior temperature sensor illustrate exemplary locations for each temperature sensor for measuring the temperature of the grain at various pre-selected levels (e.g. every foot or random levels). It can be appreciated that more than one transmitter unit 50 and more than one sensor may be positioned within a grain bin 12.

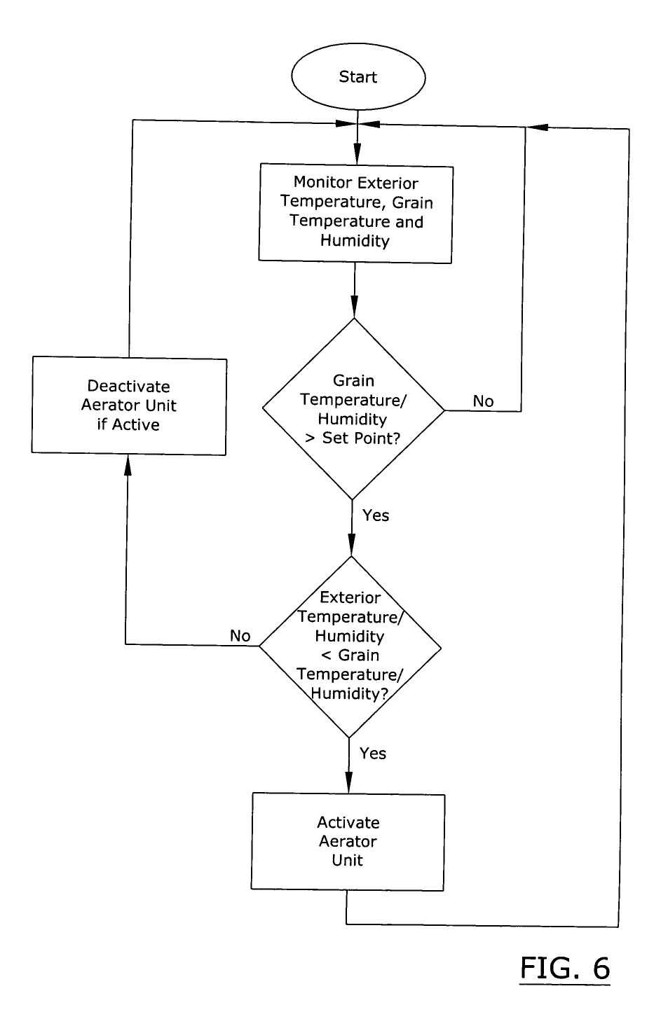

In addition, the transmitter unit 50 may be capable of communicating with an aerator unit 18 for controlling an aerator unit 18 based upon the condition data. For example, if the interior humidity exceeds a desired level and the exterior humidity is below this level, the transmitter unit 50 may automatically activate the aerator unit 18 to assist in lowering the interior humidity of the grain bin 12 as shown in FIG. 6 of the drawings. If the interior humidity falls below a desired level, the transmitter unit 50 may automatically deactivate the aerator unit 18 as shown in FIG. 6 of the drawings. The same routine may be applied to the aerator unit 18 based upon the grain temperature and the exterior temperature to maintain the grain at a desired level.

F. Alarm Condition Notification

If an alarm condition exists (e.g. high humidity, high temperature, low grain level 14, etc.), the main station 20 preferably notifies a user of the condition. Various means of automatically notifying the user such as but not limited to e-mail, instant message, paging, phone call, facsimile or other communication means. More than one means of communication may be utilized to notify the user of an alarm condition. It is preferable to include information relating to the alarm condition.

G. Operation of Invention

In operation, the grain bin 12 is monitored through the sensors 40, 41, 42, 44, 46. The sensors 40, 41, 42, 44, 46 transmit the condition data (e.g. grain level 14, grain temperature, exterior temperature, interior humidity, exterior humidity, etc.) to their respective transmitter units 50 as shown in FIG. 3 of the drawings. The transmitter units 50 then automatically or periodically transmit the condition data to the central unit 60 as shown in FIG. 2 of the drawings. The central unit 60 then automatically or periodically transmits the combined condition data to the main station 20.

The main station 20 may be connected to the Internet 16 thereby allowing the user to access the condition data via the Internet 16 through a webpage or similar data transfer means. The condition data may then be viewed, printed or manipulated by the user as desired to monitor the grain bins 12.

If an alarm condition exists, the user is then notified through a desired communication means of the alarm condition so the appropriate action may be taken. In addition, if the temperature and/or humidity within the grain bin 12 exceeds a set point, the aerator unit 18 for the individual grain bin 12 is automatically activated by the corresponding transmitter unit 50 as shown in FIGS. 3 and 6 of the drawings.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A grain bin monitoring system, comprising:
a main station;
a transmitter unit in communication with said main station;
at least one sensor positionable within a grain bin for determining condition data with respect to a grain bin, wherein said sensor is in communication with said transmitter unit for providing said condition data to said transmitter unit, wherein said transmitter unit automatically forwards said condition data to said main station.

2. The grain bin monitoring system of claim 1, wherein said main station provides said condition data to a computer via a global computer network.

3. The grain bin monitoring system of claim 1, wherein said sensor is comprised of an interior temperature sensor that measures the interior temperature of a grain bin.

4. The grain bin monitoring system of claim 3, wherein said interior temperature sensor measures the temperature of grain at various levels.

5. The grain bin monitoring system of claim 1, wherein said sensor is comprised of an exterior temperature sensor for measuring the temperature exterior of a grain bin.

6. The grain bin monitoring system of claim 1, wherein said sensor is comprised of an exterior temperature sensor for measuring the temperature exterior of a grain bin and an interior temperature sensor that measures the interior temperature of a grain bin.

7. The grain bin monitoring system of claim 1, wherein said sensor is comprised of a level sensor positionable within a grain bin for measuring a grain level within a grain bin.

8. The grain bin monitoring system of claim 1, wherein said sensor is comprised of a humidity sensor for measuring the humidity level within a grain bin.

9. The grain bin monitoring system of claim 1, wherein said sensor is comprised of:
an interior temperature sensor that measures the interior temperature of a grain bin;
exterior temperature sensor for measuring the temperature exterior of a grain bin;
a level sensor positionable within a grain bin for measuring a grain level within a grain bin; and
a humidity sensor for measuring the humidity level within a grain bin.

10. The grain bin monitoring system of claim 1, wherein said transmitter unit is capable of communicating with an aerator unit for controlling an aerator unit based upon said condition data.

11. A grain bin monitoring system, comprising:
a main station;
a central unit in communication with said main station;
a plurality of transmitter units in communication with said central unit;
at least one sensor positionable within a grain bin for determining condition data with respect to a grain bin, wherein said sensor is in communication with one of said transmitter units for providing said condition data to said transmitter unit, wherein said transmitter unit automatically forwards said condition data to a central unit which automatically forwards said condition data to said main station.

12. The grain bin monitoring system of claim 11, wherein said main station provides said condition data to a computer via a global computer network.

13. The grain bin monitoring system of claim 11, wherein said sensor is comprised of an interior temperature sensor that measures the interior temperature of a grain bin.

14. The grain bin monitoring system of claim 13, wherein said main station notifies an individual in the event of an alarm condition.

15. The grain bin monitoring system of claim 11, wherein said transmitter unit is capable of communicating with an aerator unit for controlling an aerator unit based upon said condition data.

16. The grain bin monitoring system of claim 11, wherein said sensor is comprised of an exterior temperature sensor for measuring the temperature exterior of a grain bin and an interior temperature sensor that measures the interior temperature of a grain bin.

17. The grain bin monitoring system of claim 11, wherein said sensor is comprised of a level sensor positionable within a grain bin for measuring a grain level within a grain bin.

18. The grain bin monitoring system of claim 11, wherein said sensor is comprised of a humidity sensor for measuring the humidity level within a grain bin.

19. The grain bin monitoring system of claim 11, wherein said sensor is comprised of:
an interior temperature sensor that measures the interior temperature of a grain bin;
exterior temperature sensor for measuring the temperature exterior of a grain bin;
a level sensor positionable within a grain bin for measuring a grain level within a grain bin; and
a humidity sensor for measuring the humidity level within a grain bin.

20. A grain bin monitoring method, said method comprising the steps of:
(a) determining an interior temperature within a grain bin;
(b) determining a grain level within said grain bin;
(c) determining a humidity level within said grain bin;
(d) accumulating said interior temperature, said grain level and said humidity level into a condition data;
(e) transmitting said condition data to a central unit;
(f) repeating steps (a) through (e) for any remaining grain bins;
(g) transmitting said condition data to a main station; and
(h) accessing said condition data via a computer.
